(19) United States
(12) Patent Application Publication
(10) Pub. No.: US 2026/0162278 A1
(43) Pub. Date: Jun. 11, 2026

(54) IMAGE TOKEN PRUNING FOR MULTIMODAL FOUNDATION MODELS

(71) Applicant: Intel Corporation, Santa Clara, CA (US)

(72) Inventors: Palanivel Guruva Reddiar, Gilbert, AZ (US); Venkata Ajay Kolla, Hyderabad (IN); Suresh Vasu, Bengaluru (IN)

(73) Assignee: Intel Corporation, Santa Clara, CA (US)

(21) Appl. No.: 19/538,554

(22) Filed: Feb. 12, 2026

(51) Int. Cl. G06T 7/215; B25J 9/16; G06V 10/764

(52) U.S. Cl. CPC G06T 7/215; B25J 9/1697; G06V 10/764

(57) ABSTRACT

Systems, apparatus, articles of manufacture, and methods are disclosed for reducing computational load of a multimodal foundation model processing video/image data and text data. A disclosed example system decodes a video stream, segments a video frame into patches, and generates tokens for the patches. Motion information derived from encoded motion vectors or optical flow is used to classify the patches as motion or no motion. Tokens representing no motion patches are pruned at one or more layers of the multimodal foundation model according to a pruning ratio that may be adjusted based on system status information such as power or temperature. The remaining tokens are forwarded to the model, which produces predictions such as object detections or actions. The token pruning reduces token count, thereby lowering latency, memory, and/or power consumption while maintaining inference accuracy.

### BACKGROUND

Multimodal foundation models include generative artificial intelligence (AI) models that are capable of processing input data having multiple modes. Such input data may include a combination of two or more of image/video data, text data, audio data, or sensor data. Multimodal foundation models include vision language models (VLMs) and vision language action (VLA) models. Vision language models operate on a combination of input image/video data and input text data to output video analytics, video summaries, etc. Vision language action models operate on a combination of input image/video data and input text data to output instructions, commands, etc., to cause equipment to perform actions.

### BRIEF DESCRIPTION OF THE DRAWINGS

FIG. 1 is a block diagram of an example environment in which example motion-based pruning circuitry operates to perform image token pruning for multimodal foundation models in accordance with teachings of this disclosure.

FIG. 2 is a block diagram of an example inference system including an example implementation of the motion-based pruning circuitry of FIG. 1 structured to provide image tokens to an example multimodal foundation model.

FIG. 3 is a block diagram of an example implementation of dynamic pruning circuitry included in the motion-based pruning circuitry of FIG. 2.

FIGS. 4-5 illustrate example inference results achieved by the example multimodal foundation model of FIG. 2 with and without image token pruning performed by the motion-based pruning circuitry of FIG. 2.

FIGS. 6-8 are flowcharts representative of example machine-readable instructions and/or example operations that may be executed, instantiated, and/or performed by example programmable circuitry to implement the example motion-based pruning circuitry of FIGS. 2-3.

FIG. 9 is a block diagram of an example processing platform including programmable circuitry structured to execute, instantiate, and/or perform the example machine-readable instructions and/or perform the example operations of FIGS. 6-8 to implement the motion-based pruning circuitry of FIG. 2.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine-readable instructions of FIGS. 6-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Some multimodal foundation models combine one or more language models, such as large language models (LLMs), that process input text data with one or more non-text data encoders to collectively operate as a generative AI model. Such a generative AI model is capable of understanding and processing input data including text data and non-text data or, in other words, input data having multiple modes or that is multimodal. In some examples, the non-text data encoder included in the multimodal foundation model is a video encoder or image encoder that encodes input video frame data or image data into tokens (e.g., also referred to as image tokens, video tokens, etc.) capable of being understood and processed by the LLM of the multimodal foundation model.

In some examples, the multimodal foundation model is referred to as a vision language model or a vision language action model depending on the output produced by the model. For example, vision language models may operate on input video and/or image data and input text data to output data, such as video analytics, video summaries, etc., associated with the input video and/or image data. In contrast, vision language action models may operate on input video and/or image data and input text data to output instructions, commands, etc., to cause equipment such as robots, actuators, etc., to perform actions responsive to the input video and/or image data.

Some multimodal foundation models that operate on video data, such as vision language models and vision language action models, transform images, also referred to as frames, of the video data into image tokens that can be input to the LLM of the multimodal foundation model. In some examples, the multimodal foundation models utilize a video encoder trained on pairs of image data and text data to encode (e.g., transform, convert, etc.) the input image data into feature data capable of describing the image data. The video encoder may then include the feature data in one or more tokens, such as image tokens, associated with the image, or further encode (e.g., transform, convert, etc.) the feature data into tokenized data for inclusion in the one or more image tokens associated with the image. In some examples, the video encoder may further segment the input image into blocks or other regions of pixels, which are referred to as patches or image patches. In some such examples, the video encoder then encodes the patches into respective feature data associated respectively with the patches, and includes or otherwise encodes the respective feature data into respective image tokens associated respectively with the patches of the input image.

In some examples, the LLM of a multimodal foundation model operates on the image tokens of the input image, as well as text data, such as text tokens, determined from an input text prompt, to generate one or more outputs, such as output data, output instructions/commands, etc. Recent advancements in multimodal foundation models have enhanced accuracy by increasing the size (e.g., length) of the image tokens, resulting in image tokens that can be substantially larger than tokens associated with other modes of data, such as the text tokens. However, increasing the size of the visual tokens can raise computational costs and/or have other negative performance effects. For example, multimodal foundation models implemented on edge servers with limited compute and/or memory capacity may experience degradation in one or more key performance indicators (KPIs), such as throughput, memory, power, latency, etc., due to increased image token size.

Example methods, apparatus, articles of manufacture (e.g., computer-readable medium), systems, etc., disclosed herein implement example image token pruning techniques as a technical solution to the foregoing technical problems associated with increased image token size. Example image token pruning techniques disclosed herein prune (e.g., drop, skip, discard, etc.) one or more of the image tokens at one or more layers of the multimodal foundation model to reduce the computation costs and/or other performance degradation(s) caused by the increased size of the individual tokens. As disclosed in further detail below, example image token pruning techniques leverage available motion information associated with the input image to reduce the number of image tokens input or otherwise provided to one or more layers of the multimodal foundation model, thereby reducing the total amount of image token data processed by those layer(s). Such a reduction of the total amount of image token data can reduce the compute, power, latency and/or memory requirements without compromising the model's inference accuracy because the size (e.g., length) of the individual image tokens remains unchanged.

Such technical benefits can be achieved because the image tokens contain redundancies in both the spatial and temporal domains. In some examples, the redundancies have already been encoded in the input image data (e.g., by the video encoders in the cameras) in the form of motion information, such as motion vectors, which can be leveraged by example image token pruning techniques disclosed herein to prune image tokens that are or have a likelihood of being redundant relative to other image tokens. For example, edge servers may receive video frames in compressed form. At least some example image token pruning techniques disclosed herein utilize motion information associated with an input image (e.g., an input video frame) to identify patches of the image as associated with motion (referred to as motion patches) or not associated with motion (referred to herein as no-motion patches). Some such examples further identify and tag the image tokens associated with the motion patches as motion image tokens (e.g., image tokens associated with motion), and identify and tag the image tokens associated with the no-motion patches as no-motion image tokens (e.g., image tokens not associated with motion). Then, some example image token pruning techniques disclosed herein prune (e.g., drop) one or more, or all, of the no-motion image tokens (which are associated with the no-motion patches) at the input layer of the multimodal foundation model and/or at one or more other layers of the model. However, in some examples, the motion image tokens (which are associated with the motion patches) are not pruned at the input layer and/or the other layer(s) of the multimodal foundation model. Because the no-motion image tokens are associated with no-motion patches that may be redundant over successive image frames of the video, pruning the no-motion image tokens can achieve improved throughput and/or latency, and/or reduced compute, memory bandwidth and/or power utilization, without sacrificing inference accuracy.

Example image token pruning techniques disclosed herein enable operation of multimodal foundation models with reduced latency/processing time per input video frame relative to other models not employing such pruning. Thus, example image token pruning techniques disclosed herein can enable low-latency, real-time edge AI applications, such as security and surveillance, network video recorders, retail self-checkout, etc. For example, some image token pruning techniques disclosed herein enable customers to identify events, such as an intrusion or intrusion detection, quickly so that corrective action can be initiated. Reductions in compute, memory bandwidth and/or power utilization achievable by disclosed example image token pruning techniques can lead to improvements in performance per watt and performance per cost, enabling workload consolidation scenarios in which additional processing can still be handled by an existing processor platform without the need to add specialized components, such as a discrete graphics card. For edge deployments with harsh weather conditions, because disclosed example image token pruning techniques can reduce the amount of processing without compromising the accuracy, the operating frequency of the edge server can be lowered to prevent thermal issues and extend the lifetime of the silicon. Furthermore, in edge use cases such as autonomous mobile robots, automated industrial forklifts, humanoid robots, etc., example image token pruning techniques can reduce the power requirements associated with multimodal foundation models, which may lead to longer battery life, which is another KPI in such applications.

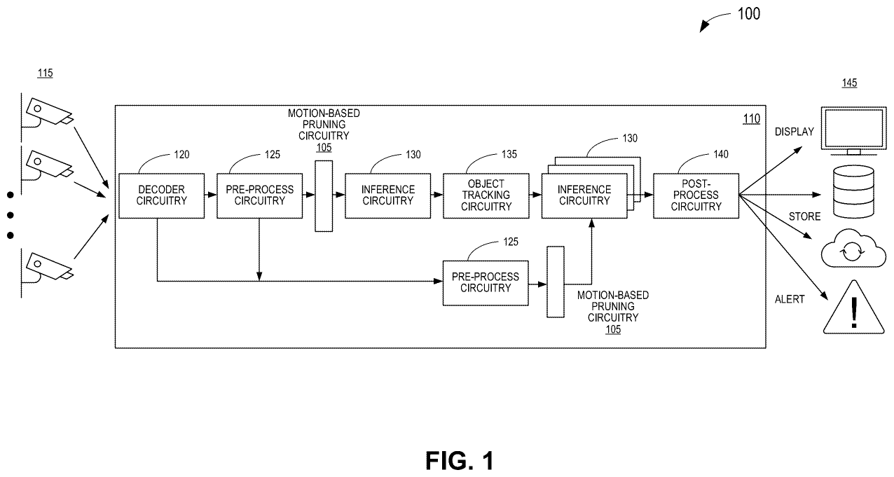

Turning to the figures, FIG. 1 is a block diagram of an example environment 100 in which example motion-based pruning circuitry 105 operates to perform image token pruning for multimodal foundation models in accordance with teachings of this disclosure. The example environment 100 includes an example edge server 110 that implements an example multimodal foundation model in the form of an example vision language model that outputs video analytics associated with one or more input video streams. The edge server 110 of the illustrated example receives example video streams from example cameras 115. The edge server 110 of the illustrated example includes example decoder circuitry 120 to decode the video streams from the cameras 115. The edge server 110 of the illustrated example includes instances of example pre-process circuitry 125 to perform pre-processing, such as color space conversion, scaling, cropping, etc., on the decoded video data. The edge server 110 of the illustrated example includes instances of example inference circuitry 130 to implement multiple multimodal foundation models to determine video analytics associated with the input video streams. The edge server 110 of the illustrated example also includes example object tracking circuitry 135 to perform object detection and tracking in support of determination of the video analytics associated with the input video streams. The edge server 110 of the illustrated example further includes example post-process circuitry 140 to format the video analytics data output from the multimodal foundation model(s) implemented by the inference circuitry 130, store the video analytics data, generate alert(s) based on the video analytics data, etc.

The edge server 110 of the illustrated example further includes instances of the example motion-based pruning circuitry 105 to prune tokens, such as image tokens, at one or more layers of the multimodal foundation models implemented by the instances of the inference circuitry 130. The motion-based pruning circuitry 105 utilizes motion information associated with image tokens to prioritize which image tokens to prune. The motion information may include magnitudes of motion vectors associated with the image patches corresponding to the image tokens, frequency domain coefficients in the encoded video data from which the image tokens are generated, optical flow data determined from the image frames of the video streams, etc. The motion-based pruning circuitry 105 of the illustrated example evaluates such motion information associated with the image tokens to identify and tag the image tokens as motion image tokens (e.g., image tokens associated with motion in their corresponding image patches) or no-motion image tokens (e.g., image tokens not associated with motion in their corresponding image patches).

Analyses of multimodal foundation models have shown that image tokens associated with motion (e.g., motion image tokens) tend to have larger attention scores than in the multimodal foundation model than image tokens not associated with motion (e.g., no-motion image tokens). The larger attention scores associated with the motion image tokens indicate the multimodal foundation models rely on the motion image tokens more than the no-motion image tokens when performing inference. The motion-based pruning circuitry 105 takes advantage of this behavior by pruning the no-motion image tokens to reduce the total amount of image token data processed by the multimodal foundation model, while retaining the motion image tokens on which inference is largely based, thereby retaining inference accuracy.

As such, the motion-based pruning circuitry 105 of the illustrated example supports several operating scenarios. For example, the motion-based pruning circuitry 105 can prune no-motion image tokens at the input layer of a multimodal foundation model, thereby reducing computational complexity of the model. Additionally or alternatively, the motion-based pruning circuitry 105 can implement intelligent dynamic pruning at the input layer or one or more layers to meet a particular pruning threshold (e.g., which may be pre-configured, specified as a user input, determined dynamically, etc.) by prioritizing the pruning of no-motion patches over motion patches, which can be useful in scenarios where multiple image tokens have similar attention scores. Such intelligent pruning can be achieved through tagging (e.g., labelling) the image tokens as motion image tokens or no-motion image tokens, evaluating the tags (e.g., labels) of the image tokens at different layers of the model, and pruning at least some of the no-motion tokens to meet respective pruning thresholds associated with those layers.

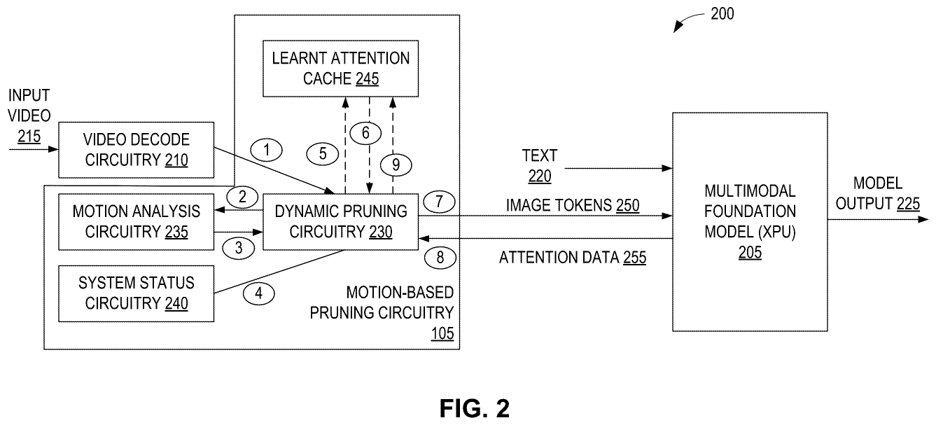

FIG. 2 is a block diagram of an example inference system 200 including an example implementation of the motion-based pruning circuitry 105 of FIG. 1 structured to provide image tokens to an example multimodal foundation model 205. The motion-based pruning circuitry 105 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the motion-based pruning circuitry 105 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The inference system 200 of the illustrated example includes the multimodal foundation model 205, the motion-based pruning circuitry 105 and example video decoder circuitry 210. The multimodal foundation model 205 of the illustrated example can be implemented by any multimodal foundation model or combination of multimodal foundation models. For example, the multimodal foundation model 205 can be any vision language model and/or vision language action model implemented by one or more compute devices, processor circuits, etc., such as one or more central processing units (CPUs), one or more graphics processing units (GPUs), one or more infrastructure processing units (IPUs), etc., and/or any other types or combinations of processing units (e.g., XPUs).

The multimodal foundation model 205 of the illustrated example is structured to perform inference based on example input video data 215 and example input text data 220 to produce an example model output 225. The input video data 215 can be any type of video data, image data, etc. For example, the input video data 215 can correspond to the video stream(s) from the camera(s) 115 in the example environment 100 of FIG. 1, streaming video data, one or more stored video files, etc. The input text data 220 can be a text string, such as a text prompt, that specifies or otherwise conditions the inference to be performed by the multimodal foundation model 205 based on the input video data 215. For example, the input video data 215 can correspond to video stream(s) from the camera(s) 115 that are positioned to monitor a geographic area, and the input text data 220 can be a text string prompting the multimodal foundation model 205 to detect people in the input video, activate a vehicle's brakes if a person is detected in the path of the vehicle, etc.

The video decoder circuitry 210 of the illustrated example implements any appropriate video decoding algorithm or algorithms to decode example input video data 215 to be processed by the inference system 200. The video decoder circuitry 210 provides the decoded video data to the motion-based pruning circuitry 105. The motion-based pruning circuitry 105 of the illustrated example, in turn, segments image frames of the decoded video data into patches and tokenizes the respective patches into corresponding image tokens, as described above. As described above, the motion-based pruning circuitry 105 of the illustrated example further classifies the image tokens as motion image tokens or no-motion image tokens and selects one or more of the classified tokens for pruning at one or more layers of the multimodal foundation model 205. In some examples, the motion-based pruning circuitry 105 classifies the image tokens as motion image tokens or no-motion image tokens prior to inference being performed by the multimodal foundation model 205.

For example, the motion-based pruning circuitry 105 includes example dynamic pruning circuitry 230 to partition the image frames (or down-scaled versions of the image frames) of the input decoded video data into patches, and tokenize the respective patches into corresponding image tokens, classify the image tokens as motion image tokens or no-motion image tokens, and select one or more of the classified tokens for pruning at one or more layers of the multimodal foundation model 205. The motion-based pruning circuitry 105 of the illustrated example further includes example motion analysis circuitry 235, example system status circuitry 240 and an example learnt attention cache 245 to support the token pruning operations performed by the dynamic pruning circuitry 230.

As mentioned above, the motion-based pruning circuitry 105 takes advantage of available motion information to classify the image tokens of the respective patches of an image frame as motion image tokens or no-motion image tokens. In some examples, the available motion information includes motion vectors included in the input video data 215 and provided by the video decode circuitry 210 to the dynamic pruning circuitry 230. In some such examples, the dynamic pruning circuitry 230 uses the magnitude(s) of the motion vector(s) associated with a given patch of an image frame to classify the patch as a motion patch or a no-motion patch and/or to classify the image token associated with that patch as a motion image token or a no-motion image token.

Additionally or alternatively, in some examples, the available motion information includes optical flow data and/or other motion data determined by the motion analysis circuitry 235. For example, the motion analysis circuitry 235 can implement any appropriate technique to compute optical flow data (e.g., optical flow vectors) and/or other motion data for an image frame based on comparisons of the image frame with prior and/or subsequent image frames of the decoded video data. In some such examples, the dynamic pruning circuitry 230 uses the optical flow data (e.g., such as magnitude(s) of the optical flow vector(s)) and/or other motion data obtained from the motion analysis circuitry 235 for a given patch of an image frame to classify the patch as a motion patch or a no-motion patch and/or to classify the image token associated with that patch as a motion image token or a no-motion image token. Further details concerning operation of the dynamic pruning circuitry 230 to classify image tokens are provided below.

In the illustrated example, the dynamic pruning circuitry 230 identifies/selects image tokens for pruning based on one or more pruning thresholds. For example, a pruning threshold may specify a number, percentage, ratio, etc., of image tokens to be pruned at a particular layer or layers of the multimodal foundation model 205. In some examples, the pruning threshold may be a static value (e.g., based on initialization information, user input information, etc.) and/or a dynamic value determined dynamically by the dynamic pruning circuitry 230.

In some examples, the dynamic pruning circuitry 230 uses system status information provided by the system status circuitry 240 to determine, compute or otherwise set one or more pruning thresholds to be used to prune the image tokens at one or more layers of the multimodal foundation model 205. For example, the system status circuitry 240 may obtain system status information, such current power utilization, measured temperature, etc., associated with the inference system 200 (e.g., associated with a compute device implementing the inference system 200). In some such examples, the dynamic pruning circuitry 230 determines the pruning threshold associated with a layer of the multimodal foundation model 205, such as the input layer of the multimodal foundation model 205, based on the current power utilization, measured temperature, etc., provided by the system status circuitry 240. For example, the dynamic pruning circuitry 230 may sample the system information (e.g., power utilization, measured temperature, etc.) provided by the system status circuitry 240 at a sampling interval, frequency, etc., and set or update the pruning threshold based on the sampled values of the system information (e.g., power utilization, measured temperature, etc.). By way of example, the dynamic pruning circuitry 230 may increase the pruning threshold (e.g., to increase the number/percentage/ratio of image tokens to be pruned and, thus, reduce system utilization) responsive to an increase in the system's power utilization, measured temperature, etc., and may decrease the pruning threshold (e.g., to decrease the number/percentage/ratio of image tokens to be pruned and, thus, permit increased system utilization) responsive to decrease in the system's power utilization, measured temperature, etc. Further details concerning operation of the dynamic pruning circuitry 230 to set pruning threshold(s) and/or other identify/select image tokens for pruning are provided below.

In some examples, the dynamic pruning circuitry 230 may utilize information stored in the learnt attention cache 245 to classify the image tokens and motion image tokens or no-motion image tokens, and/or to identify/select image tokens for pruning. The learnt attention cache 245 may be implemented by any number(s) and/or type(s) of memory, storage devices, etc. In the illustrated example, the learnt attention cache 245 stores the image tokens for a current image frame to be processed by the multimodal foundation model 205, as well as one or more additional fields associated with the individual image tokens. For example, one of the fields associated with the individual image tokens includes the motion/no-motion classification of the individual image tokens.

As mentioned above, image tokens associated with motion (e.g., motion image tokens) tend to have larger attention scores in the multimodal foundation model 205 than image tokens not associated with motion (e.g., no-motion image tokens). The larger attention scores associated with the motion image tokens indicate the multimodal foundation model 205 relies on the motion image tokens more than the no-motion image tokens when performing inference. As such, in some examples, another field maintained by the learnt attention cache 245 for the individual image tokens includes attention information (e.g., attention scores) obtained by the dynamic pruning circuitry 230 from the multimodal foundation model 205 for patches of a previous image frame. In some examples, the dynamic pruning circuitry 230 uses the cached attention information (e.g., attention scores) for the patches of a previous frame to identify/select which image tokens of a current image frame are to be pruned. For example, the dynamic pruning circuitry 230 may prioritize pruning of no-motion image tokens associated with patches having lower attention scores in a previous frame than no-motion image tokens associated with patches having higher attention scores in the previous frame. Additionally or alternatively, in some examples, if pruning of all the no-motion image tokens fails to satisfy the pruning threshold, the dynamic pruning circuitry 230 may then prune motion image tokens in increasing order of previous frame attention scores.

In some examples, the learnt attention cache 245 maintains one or more other fields associated with the individual image tokens for the current image frame. For example, the learnt attention cache 245 may maintain a field to specify how correlated the patches associated with the image tokens are to spatially neighboring patches. As another example, the learnt attention cache 245 may maintain a field to characterize the image encoding type of the patches associated with the individual image tokens (e.g., such as inter-frame coding, intra-frame coding, skip coding, etc.). As yet another example, the learnt attention cache 245 may maintain a field to characterize the frequency domain coefficients used to represent the patches associated with the individual image tokens in the encoded input video data 215.

As described in further detail below, the dynamic pruning circuitry 230 may cause the contents of the learnt attention cache 245 to be reset (e.g., evicted, cleared, etc.) at the start of inference associated with input video data 215. As inference progresses, the dynamic pruning circuitry 230 populates the learnt attention cache 245 with the image tokens determined for the current image frame, their respective motion classifications (e.g., motion/no-motion), their prior-frame attention scores, and other information stored in the cache fields. In some examples, the dynamic pruning circuitry 230 also performs scene change detection on the input video data 215 and resets (e.g., evicts, clears, etc.) the learnt attention cache 245 based on detection of a scene change.

As shown in the illustrated example of FIG. 2, the dynamic pruning circuitry 230 outputs example classified image tokens 250 (e.g., the image tokens that have not been pruned) to the input layer of the multimodal foundation model 205. In some examples, because the classified image tokens 250 are tagged with their respective motion classifications, the classified image tokens 250 may be pruned at one or more other layers of the multimodal foundation model 205. As shown in the illustrated example of FIG. 2, the dynamic pruning circuitry 230 also receives example attention data 255 from the multimodal foundation model 205, such as the attention scores for the patches of a previous image frame, as described above.

Reference numerals 1-9 of FIG. 2 also illustrate an example pruning procedure performed by the motion-based pruning circuitry 105. The procedure begins with the video decoder circuitry 210 providing the decoded video data for the current image frame to the dynamic pruning circuitry 230 (corresponding to reference numeral 1). In some examples, the video decoder circuitry 210 also provides motion vectors, encoded frame type, transform coefficient data, etc., associated with the current image frame to the dynamic pruning circuitry 230.

In some examples, the dynamic pruning circuitry 230 provides the current decoded image frame and a previous decoded image frame to the motion analysis circuitry 235 (corresponding to reference numeral 2). In the illustrated example, the motion analysis circuitry 235 performs optical flow analysis on the current and previous decoded image frames to determine optical flow data, such as optical flow vectors, for the current image frame. The motion analysis circuitry 235 returns the optical flow data/vectors to the dynamic pruning circuitry 230 (corresponding to reference numeral 3).

In the illustrated example, the dynamic pruning circuitry 230 queries the system status circuitry 240 to obtain the current system status information (e.g., power utilization, thermal data, etc.) for a current sample interval (corresponding to reference numeral 4). In the illustrated example, the dynamic pruning circuitry 230 also retrieves the cached data from the learnt attention cache 245 (corresponding to reference numeral 5). Next, the dynamic pruning circuitry 230 uses the motion vectors and/other decoded video information (e.g., obtained at reference numeral 1), the optical flow data/vectors (obtained at reference numeral 3), the system status information (obtained at reference numeral 4) and the learnt cache data (obtained at reference numeral 5) to classify one of the image tokens of the patches of the current image frame as motion image tokens or no-motion image tokens, determine the token pruning threshold(s) and identify/select one or more of the classified image tokens for pruning (corresponding to reference numeral 6). In some examples, the dynamic pruning circuitry 230 populates a token pruning map or other data structure in the learnt attention cache 245 to identify the image tokens to be pruned (e.g., by specifying the corresponding patch locations of the pruned image tokens in the map). In some examples, the dynamic pruning circuitry 230 also populates the field of the image tokens in the learnt attention cache 245 with the motion/no-motion classifications and other information described above.

In some examples, the dynamic pruning circuitry 230 prunes the identified/selected image tokens based on the pruning threshold and provided the remaining unpruned image tokens to the input layer of the multimodal foundation model 205 (corresponding to reference numeral 7). In some examples, at reference numeral 7, the dynamic pruning circuitry 230 does not prune the image tokens but, instead, provides the image tokens, their respective motion/no-motion classifications (e.g., by applying a motion classification tag to the individual image tokens), the pruning threshold(s) and any other relevant data (e.g., such as a token pruning map) to the multimodal foundation model 205. In some such examples, the multimodal foundation model 205 performs image token pruning at one or more of the model's layers based on the information provided by the dynamic pruning circuitry 230.

In the illustrated example, the multimodal foundation model 205 performs inference based on the non-pruned image tokens applied to the model and an input text prompt. The multimodal foundation model 205 outputs the inference results, as well as the attention scores associated with the image tokens at one or more of the model's layers, to the dynamic pruning circuitry 230 (corresponding to reference numeral 8). The dynamic pruning circuitry 230 then updates the learnt attention cache 245 with the attention scores for the image tokens (corresponding to reference numeral 9). The process then repeats for the next decoded image frame.

Although described in the context of pruning image tokens, examples of the motion-based pruning circuitry 105 disclosed herein are not limited thereto. On the contrary, examples of the motion-based pruning circuitry 105 can be used to prune any type of tokens for which associated motion data is available and/or on which motion classification can otherwise be performed.

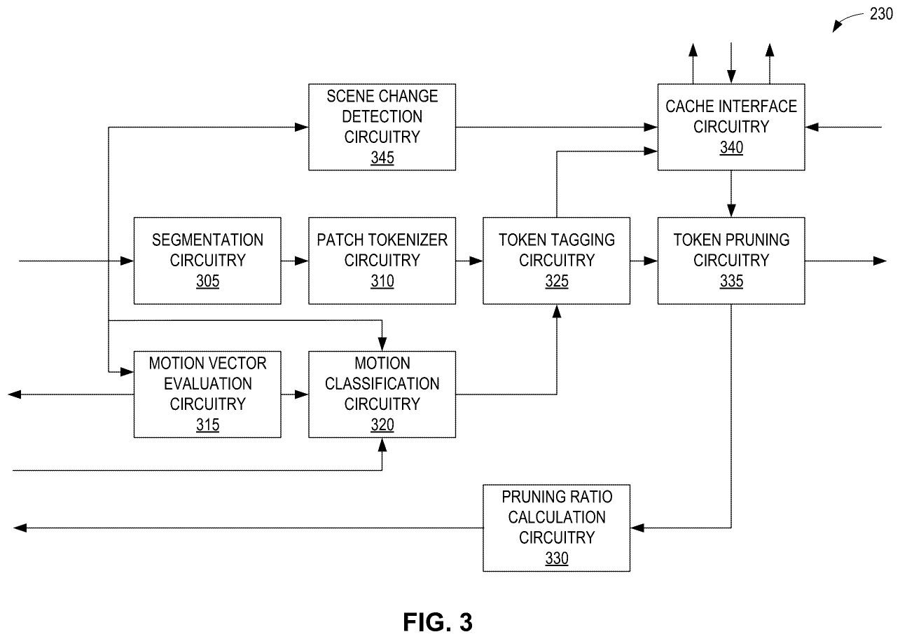

FIG. 3 is a block diagram of an example implementation of the dynamic pruning circuitry 230 included in the motion-based pruning circuitry 105 of FIG. 2. The dynamic pruning circuitry 230 of FIG. 3 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the dynamic pruning circuitry 230 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example dynamic pruning circuitry 230 of FIG. 3 includes example segmentation circuitry 305, example patch tokenizer circuitry 310, example motion vector evaluation circuitry 315, example motion classification circuitry 320, example token tagging circuitry 325, example pruning ratio calculation circuitry 330, example token pruning circuitry 335, example cache interface circuitry 340 and example scene change detection circuitry 345. The segmentation circuitry 305 of the illustrated example operates to segment an input decoded image into patches of pixels. For example, the segmentation circuitry 305 can segment the input decoded image patches to have a size of N-by-M pixels, where the values of N and M may be the same (e.g., in the case of square patches) or different (e.g., in the case of rectangular patches). For example, the patches may have sizes of 4-by-4 pixels, 8-by-8 pixels, 16-by-16 pixels, etc.

The patch tokenizer circuitry 310 of the illustrated example converts the patches of the input decoded image into respective image tokens capable of being processed by a multimodal foundation model. In some examples, the patch tokenizer circuitry 310 implements a video encoder trained on pairs of image patch data and corresponding text data that describes the image patches to encode (e.g., transform, convert, etc.) the input image patches into respective feature data capable of describing the patches. In some examples, the patch tokenizer circuitry 310 includes the feature data determined for a given image patch in an image token corresponding to that patch. In some examples, the patch tokenizer circuitry 310 encodes (e.g., transforms, converts, etc.) the feature data determined for the given image patch into encoded (e.g., tokenized) data and includes the encoded (e.g., tokenized) data in the image token corresponding to that patch.

The motion vector evaluation circuitry 315 of the illustrated example determines whether motion vectors are available for the input image patches and, thus, can be used to perform motion classification on the patches. In some examples, motion vector evaluation circuitry 315 also determines whether the motion vectors, if available, are of sufficient quality to perform motion classification on the patches. For example, the motion vector evaluation circuitry 315 can determine that motion vectors are available if the input image patches were obtained from decoded image data provided by a video decoder, such as the video decoder circuitry 210, and the motion vectors were included with the decoded image data. In some examples, the motion vector evaluation circuitry 315 also determines the motion vectors, if available, are of sufficient quality to perform motion classification on the patches based on evaluation of one or more characteristics of the encoded video data that was processed by the video decoder, such as the video decoder circuitry 210. For example, the motion vector evaluation circuitry 315 may evaluate a bit rate and/or compression factor associated with the encoded video data to evaluate a quality of the motion vectors. This is because a high bit rate can correspond to a low compression factor which is indicative of high quality encoded video data. In contrast, a low bit rate can correspond to a high compression factor, which is indicative of encoded video data that has been heavily compressed and, thus, may be of lower quality. In some such examples, the motion vector evaluation circuitry 315 may determine the motion vectors have sufficient quality if the bit rate associated with the encoded video data satisfies (e.g., meets or exceeds) a bit rate threshold and/or if the compression factor associated with the encoded video data satisfies (e.g., meets or is lower than) a compression factor threshold.

The motion classification circuitry 320 of the illustrated example performs motion classification on the input image patches based on available motion information associated with the patches. In some examples, the motion classification circuitry 320 performs motion classification based on motion vectors associated with the input image patches if the motion vector evaluation circuitry 315 determines the motion vectors are available. In some examples, the motion classification circuitry 320 performs motion classification based on motion vectors associated with the input image patches if the motion vector evaluation circuitry 315 determines the motion vectors are available and that they have sufficient quality, as described above. However, in some examples, if the motion vectors are unavailable or of insufficient quality, the motion vector evaluation circuitry 315 invokes the motion analysis circuitry 235 (or any other motion analysis algorithm) to determine motion data associated with the input image patches. For example, and as described above, the motion analysis circuitry 235 may determine optical flow data/vectors for the input image patches based on comparison of the current image with a previous image of the input video. In some such examples, the motion classification circuitry 320 then performs motion classification based on the optical flow data/vectors associated with the input image patches if the motion vector evaluation circuitry 315 determines that motion vectors are unavailable or of insufficient quality.

In the illustrated example, the motion classification circuitry 320 classifies a given input image patch of the input image patches as a motion patch or a no-motion patch based on the available motion data associated with that patch. In some examples, the motion classification circuitry 320 compares the magnitude(s) of one or more motion vectors (if motion vectors are selected for motion classification) and/or one or more optical flow vectors (if optical flow data is selected for motion classification) to a motion threshold to perform the motion classification. For example, the motion classification circuitry 320 may classify a given input image patch as a motion patch if the magnitude(s) of one or more of its motion vector(s) and/or optical flow vector(s) satisfies (e.g., meets or exceeds) the motion threshold. Conversely, the motion classification circuitry 320 may classify the given input image patch as a no-motion patch if the magnitude(s) of one or more of its motion vector(s) and/or optical flow vector(s) do not satisfy (e.g., are less than) the motion threshold.

In some examples, the motion classification circuitry 320 determines a representative motion vector (if motion vectors are selected for motion classification) and/or a representative optical flow vector (if optical flow data is selected for motion classification) to be used to perform motion classification for a given input image patch. For example, the motion classification circuitry 320 may determine the representative motion vector for the given input image patch to be the average (e.g., mean) of the motion vectors associated with the patch, the median of the motion vectors associated with the patch, the motion vector having the largest magnitude, the motion vector having the smallest magnitude, etc. Similarly, in some examples, the motion classification circuitry 320 may determine the representative optical flow vector for the given input image patch to be the average (e.g., mean) of the optical flow associated with the patch, the median of the optical flow associated with the patch, the optical flow having the largest magnitude, the optical flow having the smallest magnitude, etc. In such examples, the motion classification circuitry 320 may compare the representative motion vector (if motion vectors are selected for motion classification) and/or the representative optical flow vector (if optical flow data is selected for motion classification) to the motion threshold to classify the given input image patch as a motion patch or a no-motion patch.

As described above, the learnt attention cache 245 may store information characterizing the image encoding type of the patches of the current image frame (e.g., such as inter-frame coding, intra-frame coding, skip coding, etc.). For example, the segmentation circuitry 305 may obtain the respective image encoding types for the patches with the input decoded image data and may cause the respective image encoding types for the patches to be stored in the learnt attention cache 245 via the cache interface circuitry 340. In some such examples, the motion classification circuitry 320 may then obtain the image encoding types for the patches of the current image frame from the learnt attention cache 245 via the cache interface circuitry 340. In some examples, the motion classification circuitry 320 uses the encoding types to classify the patches of the current image frame as motion patches or no-motion patches. For example, the motion classification circuitry 320 may classify patches with an encoding type of inter-frame coding as motion patches, and may classify patches with an encoding type of intra-frame coding or skip coding as no-motion patches.

As yet another example, the learnt attention cache 245 may maintain a field or other data structure to characterize the respective frequency domain coefficients used to represent the patches of the current image frame in the encoded input video data 215. For example, the field associated with a given patch may represent a histogram of frequency domain coefficients used to represent that patch in the encoded video data. In some such examples, the segmentation circuitry 305 may obtain the respective frequency domain coefficients for the patches with the input decoded image data and may cause the respective frequency domain coefficients for the patches to be stored in the learnt attention cache 245 via the cache interface circuitry 340. In some such examples, the motion classification circuitry 320 may then obtain the frequency domain coefficients for the patches of the current image frame from the learnt attention cache 245 via the cache interface circuitry 340. In some examples, the motion classification circuitry 320 uses the frequency domain coefficients to classify the patches of the current image frame as motion patches or no-motion patches. For example, the motion classification circuitry 320 may evaluate the histograms of frequency domain coefficients for the patches of the current image frame to determine whether a count of non-zero high frequency domain coefficients (e.g., frequency domain coefficients that meet or exceed a particular frequency value) for a given patch satisfies (e.g., meets or exceeds) a threshold. In some such examples, the motion classification circuitry 320 may classify patches with counts of non-zero high frequency domain coefficients satisfying the threshold as motion patches, and may classify patches with counts of non-zero high frequency domain coefficients not satisfying the threshold as no-motion patches.

The token tagging circuitry 325 of the illustrated example classifies the image tokens corresponding to the respective input image patches as motion image tokens or no-motion image tokens. In the illustrated example, the token tagging circuitry 325 classifies a given image token as a motion image token if its corresponding image patch was classified as a motion patch. Likewise, the token tagging circuitry 325 classifies the given image token as a no-motion image token if its corresponding image patch was classified as a no-motion patch. In some examples, the token tagging circuitry 325 adds a motion classification to the given image token, such as a tag, a flag, an information element, etc., that indicates whether the given image token is classified as a motion token or a no-motion token. For example, the token tagging circuitry 325 may set the tag, flag, information element, etc., for a given image token to a first value to indicate the token is a motion image token, and may set the tag, flag, information element, etc., to a different second value to indicate the token is a no-motion image token. In some examples, the token tagging circuitry 325 of the illustrated example then writes the classified image tokens (e.g., the image tokens with their corresponding motion or no-motion classification tags, flags, information elements, etc.) to the cache interface circuitry 340 to cause the classified image tokens to be stored in the learnt attention cache 245.

The pruning ratio calculation circuitry 330 of the illustrated examples calculates a token pruning threshold in the form of a pruning ratio, which specifies a ratio or percentage of image tokens to be pruned at a layer of the multimodal foundation model 205. In the illustrated example, the pruning ratio calculation circuitry 330 queries the system status circuitry 240 (and/or other such circuitry) to obtain system status information, such as current power utilization, measured temperature, etc., associated with an inference system, such as the inference system 200, including the motion-based pruning circuitry 105 and/or implementing the multimodal foundation model 205. As described above, the pruning ratio calculation circuitry 330 may query the system status circuitry 240 at a sampling interval to obtain the current system status information, such as current power utilization, measured temperature, etc., associated with an inference system. In some examples, the pruning ratio calculation circuitry 330 computes the pruning ratio as a value between 0 and 1, with 0 representing 0% of the image tokens are to be pruned, and 1 representing 100% of the image tokens are to be pruned. In some examples, the pruning ratio calculation circuitry 330 sets the pruning ratio to achieve a target power utilization, operating temperature, etc. In some such examples, if the target power utilization exceeds a target power threshold and/or the measured operating temperature exceeds a target operating temperature, the pruning ratio calculation circuitry 330 increases the pruning ratio (e.g., in increments at successive sampling intervals) until the target power threshold and/or the target operating temperature is/are met. This is because the relatively high power utilization and/or measured temperature indicate the inference system is heavily loaded, and increasing the pruning ratio will increase the percentage of image tokens that are pruned, thereby reducing the load on the inference system. Conversely, in some such examples, if the target power utilization is less than a target power threshold and/or the measured operating temperature is less than a target operating temperature, the pruning ratio calculation circuitry 330 decreases the pruning ratio (e.g., in increments at successive sampling intervals) until the target power threshold and/or the target operating temperature is/are met. This is because the relatively low power utilization and/or measured temperature indicate the inference system is lightly loaded, and decreasing the pruning ratio will decrease the percentage of image tokens that are pruned, thereby allowing the inference system to improve accuracy by operating on more image data until the system becomes too heavily loaded. In some examples, the pruning ratio calculation circuitry 330 of the illustrated example then writes the pruning ratio to the cache interface circuitry 340 to cause the pruning ratio to be stored in the learnt attention cache 245.

The token pruning circuitry 335 of the illustrated example selects or otherwise identifies a subset of image tokens of the current input image for pruning at one or more layers of the multimodal foundation model 205. As such, the token pruning circuitry 335 of the illustrated example causes remaining image tokens not included in the subset of pruned tokens to be provided to the one or more layers of the multimodal foundation model 205. In some examples, the token pruning circuitry 335 selects the subset of image tokens for pruning at a layer of the multimodal foundation model 205 (e.g., such as the input layer of the multimodal foundation model 205) based on the motion classifications of the image tokens and the current pruning ratio. For example, the token pruning circuitry 335 may prioritize the selection of no-motion image tokens over motion image tokens for pruning, as described. In some examples, the token pruning circuitry 335 implements such prioritization by selecting no-motion image tokens for inclusion in the subset of tokens to be pruned until the pruning ratio is satisfied. In some examples, the token pruning circuitry 335 implements such prioritization by assigning selection weights to the image tokens such that no-motion image tokens have a greater likelihood of being randomly selected for pruning than no-motion image tokens.

As described above, in some examples, the token pruning circuitry 335 uses attention scores obtained from the multimodal foundation model 205 for patches of a previous image frame to select the subset of image tokens of the current image frame for pruning. For example, when selecting no-motion image tokens for pruning, the token pruning circuitry 335 may obtain the attention scores for the patches of the previous image frame from the learnt attention cache 245 via the cache interface circuitry 340. The token pruning circuitry 335 may then associate the attention scores with the corresponding image tokens of the patches in the matching patch locations of the current image frame. In some such examples, the token pruning circuitry 335 can then select the no-motion image tokens in order of increasing attention score (e.g., such that the no-motion image tokens associated with lower attention scores are pruned before no-motion image tokens associated with higher attention scores). In some examples that employ random token pruning selection based on weights, as described above, the token pruning circuitry 335 may assign weights to the image tokens based on their associated attention scores such that image tokens associated with lower attention scores have a greater likelihood of being selected for pruning than image tokens associated with higher attention scores. In some examples, if the pruning ratio is not satisfied after selection of all no-motion image tokens for pruning, the token pruning circuitry 335 continues selecting motion image tokens for pruning in order of increasing attention score (e.g., such that the motion image tokens associated with lower attention scores are pruned before motion image tokens associated with higher attention scores).

In some examples, the pruning ratio calculation circuitry 330 calculates multiple pruning ratios to be associated respectively with different layers of the multimodal foundation model 205. In some such examples, the token pruning circuitry 335 selects or otherwise identifies, based on the respective pruning ratios, different subsets of image tokens of the current input image for pruning at different layers of the multimodal foundation model 205. For example, the multimodal foundation model 205 may support dynamic pruning at one or more of its model layers in addition to, or in the alternative to, the model's input layer. In some such examples, the multimodal foundation model 205 may include a feedforward mechanism at one or more layers of the model that permits image tokens to be pruned dynamically at those one or more model layers (e.g., rather than being limited to static image token pruning at just the model's input layer). In some such examples, the token pruning circuitry 335 uses the respective subsets of image tokens selected for pruning at the input layer and/or one or more other layers of the multimodal foundation model 205 to provide respective subsets of unpruned image tokens to those different layers of the multimodal foundation model 205 via the model's feedforward mechanism.

The cache interface circuitry 340 of the illustrated example provides an interface to the learnt attention cache 245. In some examples, the cache interface circuitry 340 is implemented by one or more registers, mapped regions of memory, etc., to permit data to be written to and/or read from the learnt attention cache 245.

The scene change detection circuitry 345 of the illustrated example processes the input video data to detect scene changes in the video. As described above, scene changes may be used as triggers to reset (e.g., evict, clear, etc.) the learnt attention cache 245. The scene change detection circuitry 345 may implement any appropriate algorithm or combinations of algorithms to detect scene changes and/or other transitions in the input video data. In some examples, responsive or otherwise based on a detected scene change, the scene change detection circuitry 345 sends one or more commands, instructions, etc., to the learnt attention cache 245 to cause the learnt attention cache 245 to be reset (e.g., evicted, cleared, etc.).

Although described in the context of pruning image tokens, examples of the dynamic pruning circuitry 230 disclosed herein are not limited thereto. On the contrary, examples of the dynamic pruning circuitry 230 can be used to prune any type of tokens for which associated motion data is available and/or on which motion classification can otherwise be performed.

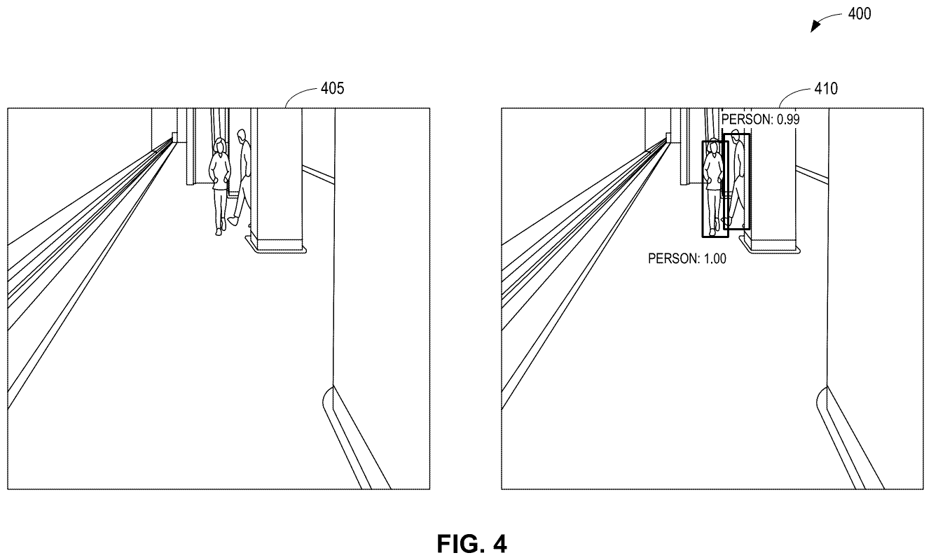

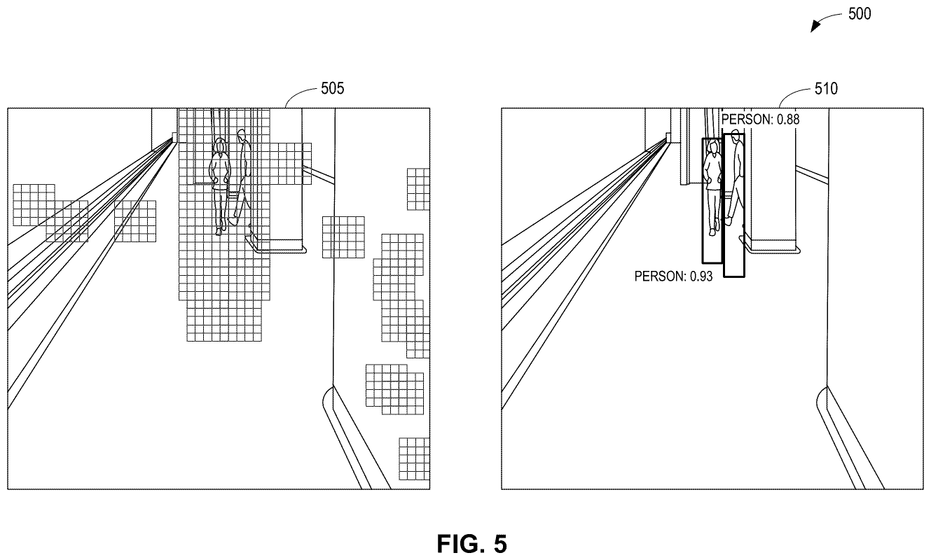

FIGS. 4-5 illustrate example inference results achieved by the example multimodal foundation model 205 of FIG. 2 with and without image token pruning performed by the motion-based pruning circuitry 105 of FIG. 2. In the illustrated example, the multimodal foundation model 205 is trained to detect people in captured video of an environment, such as a subway station. FIG. 4 depicts an example image frame 405 taken from an example video of the subway station. FIG. 4 also depicts an example inference output 410 from the multimodal foundation model 205. In the illustrated example, the inference output 410 is produced by the multimodal foundation model 205 without any pruning of the image tokens determined for the image frame 405. As can be seen in the inference output 410, the multimodal foundation model 205 correctly detects the individual persons in the video (as demonstrated by the two bounding boxes included in the inference output 410) and correctly identifies the individual persons (as demonstrated by the two “person” labels with output probability values of 1.00 and 0.98 in the inference output 410).

FIG. 5 illustrates an example of image token pruning performed by the motion-based pruning circuitry 105. In particular, FIG. 5 depicts an example set of motion patches 505 classified by the motion-based pruning circuitry 105 in the image frame 405. In the example of FIG. 5, the motion patches 505 are represented by boxes overlaid on the image frame 405. FIG. 5 also depicts an example inference output 510 from the multimodal foundation model 205 with the just the subset image tokens corresponding to the set of motion patches 505 (and, as such. with the subset of no-motion tokens being pruned from the input of the multimodal foundation model 205. As can be seen in the inference output 510, the multimodal foundation model 205 correctly detects the individual persons in the video (as demonstrated by the two bounding boxes included in the inference output 510) and correctly identifies the individual persons (as demonstrated by the two “person” labels with output probability values of 0.93 and 0.88 in the inference output 510). The multimodal foundation model 205 is able to achieve such an accurate result even though more than half of the image tokens have been pruned at the input to the model. Moreover, the multimodal foundation model 205 is able to produce the inference output 510 in substantially less time than the inference output 410 because the model processes substantially fewer image tokens when pruning is performed by the motion-based pruning circuitry 105.

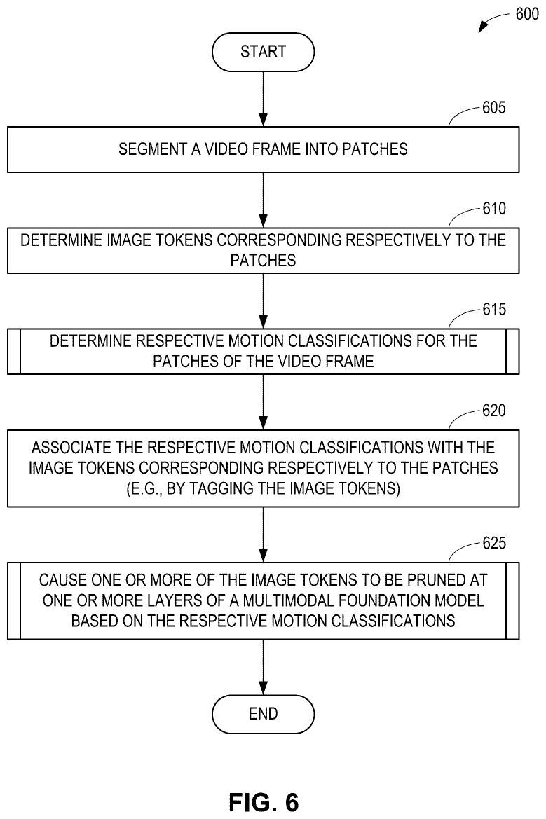

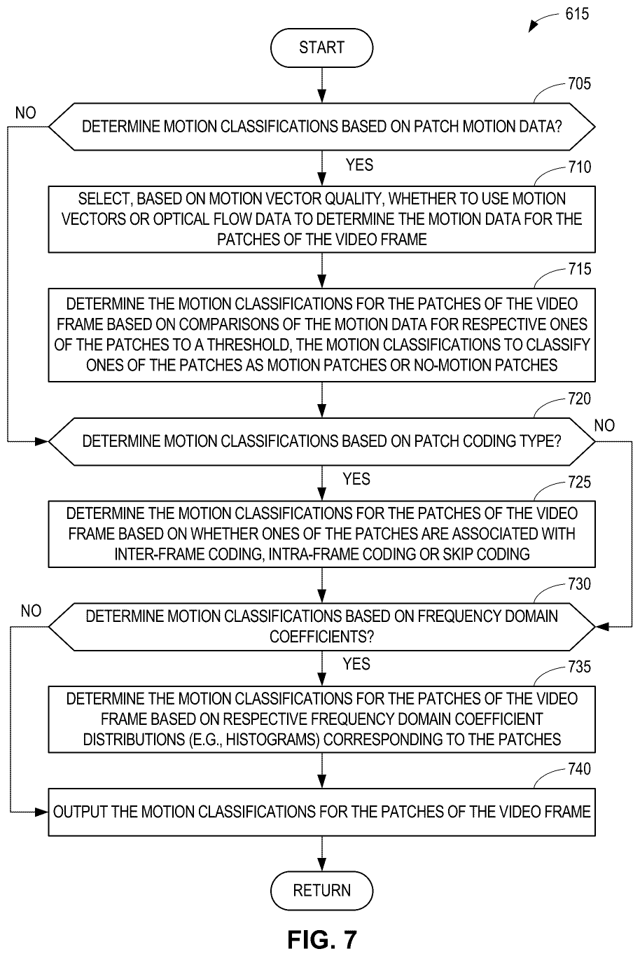

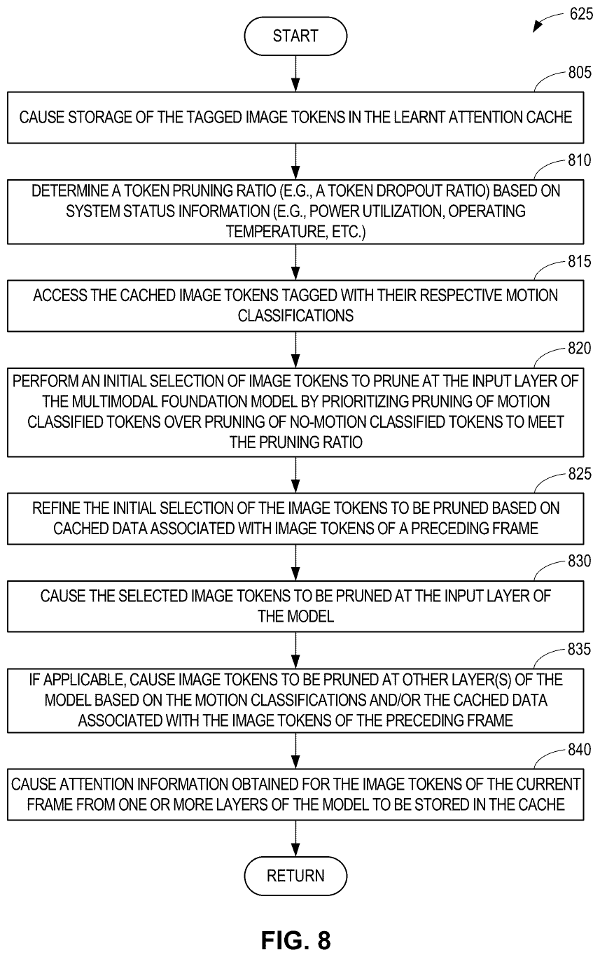

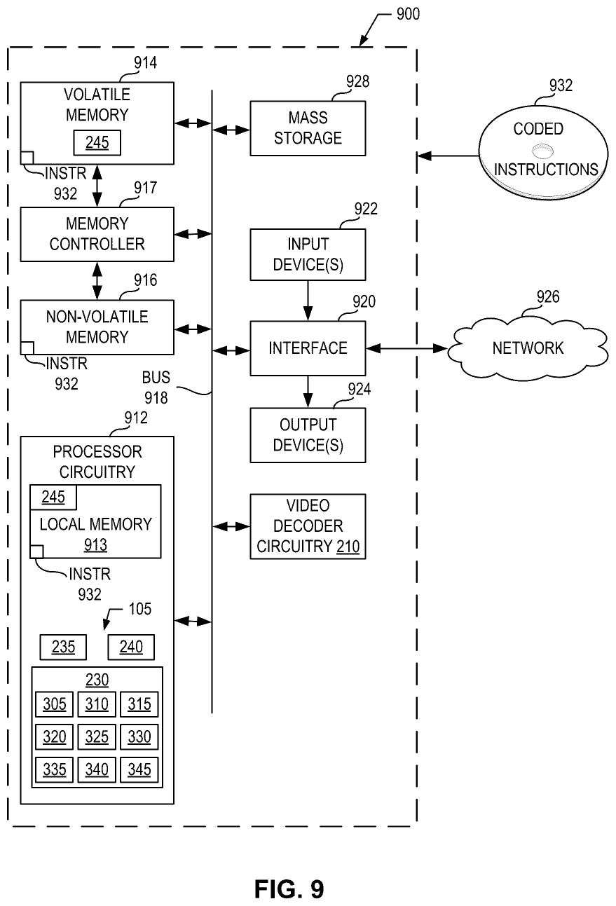

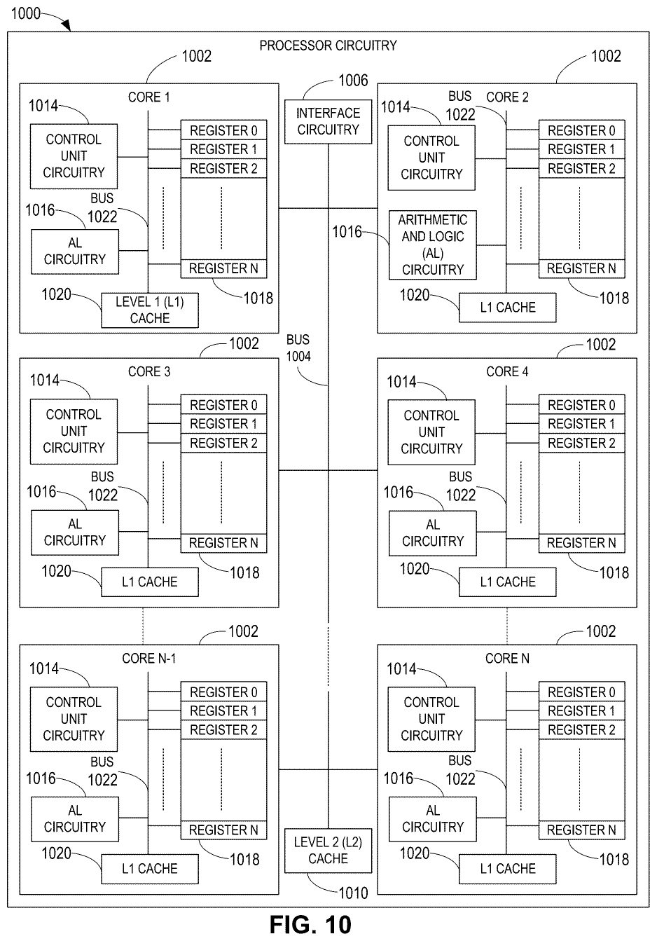

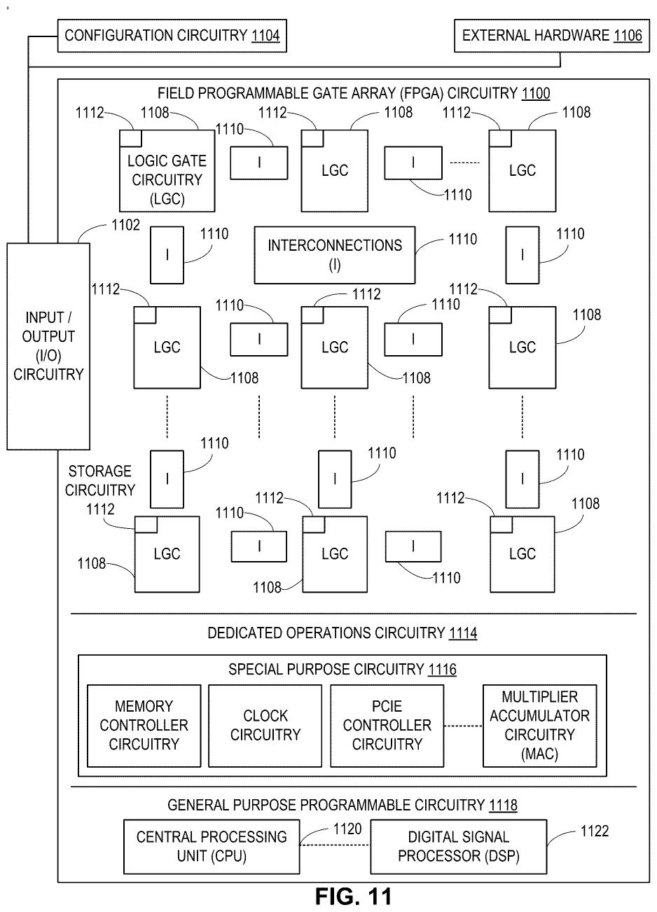

In some examples, the motion-based pruning circuitry 105 includes means for performing dynamic pruning. For example, the means for performing dynamic pruning may be implemented by the dynamic pruning circuitry 230. In some examples, the dynamic pruning circuitry 230 may be instantiated by programmable circuitry such as the example programmable circuitry 912 of FIG. 9. For instance, the dynamic pruning circuitry 230 may be instantiated by the example microprocessor 1000 of FIG. 10 executing machine executable instructions such as those implemented by at least blocks 605-625 of FIG. 6, blocks 705-740 of FIG. 7 and/or blocks 805-840 of FIG. 8. In some examples, the dynamic pruning circuitry 230 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the dynamic pruning circuitry 230 may be instantiated by any other combination of hardware, software, and/or firmware. For example, the dynamic pruning circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the dynamic pruning circuitry 230 includes means for segmenting images. For example, the means for segmenting images may be implemented by the segmentation circuitry 305. In some examples, the segmentation circuitry 305 may be instantiated by programmable circuitry such as the example programmable circuitry 912 of FIG. 9. For instance, the segmentation circuitry 305 may be instantiated by the example microprocessor 1000 of FIG. 10 executing machine executable instructions such as those implemented by at least block 605 of FIG. 6. In some examples, the segmentation circuitry 305 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the segmentation circuitry 305 may be instantiated by any other combination of hardware, software, and/or firmware. For example, the segmentation circuitry 305 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the dynamic pruning circuitry 230 includes means for determining image tokens. For example, the means for determining image tokens may be implemented by the patch tokenizer circuitry 310. In some examples, the patch tokenizer circuitry 310 may be instantiated by programmable circuitry such as the example programmable circuitry 912 of FIG. 9. For instance, the patch tokenizer circuitry 310 may be instantiated by the example microprocessor 1000 of FIG. 10 executing machine executable instructions such as those implemented by at least block 610 of FIG. 6. In some examples, the patch tokenizer circuitry 310 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the patch tokenizer circuitry 310 may be instantiated by any other combination of hardware, software, and/or firmware. For example, the patch tokenizer circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the dynamic pruning circuitry 230 includes means for evaluating motion vectors. For example, the means for evaluating motion vectors may be implemented by the motion vector evaluation circuitry 315. In some examples, the motion vector evaluation circuitry 315 may be instantiated by programmable circuitry such as the example programmable circuitry 912 of FIG. 9. For instance, the motion vector evaluation circuitry 315 may be instantiated by the example microprocessor 1000 of FIG. 10 executing machine executable instructions such as those implemented by at least block 710 of FIG. 7. In some examples, the motion vector evaluation circuitry 315 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the motion vector evaluation circuitry 315 may be instantiated by any other combination of hardware, software, and/or firmware. For example, the motion vector evaluation circuitry 315 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the dynamic pruning circuitry 230 includes means for performing motion classification. For example, the means for performing motion classification may be implemented by the motion classification circuitry 320. In some examples, the motion classification circuitry 320 may be instantiated by programmable circuitry such as the example programmable circuitry 912 of FIG. 9. For instance, the motion classification circuitry 320 may be instantiated by the example microprocessor 1000 of FIG. 10 executing machine executable instructions such as those implemented by at least block 615 of FIG. 6 and/or blocks 705-740 of FIG. 7. In some examples, the motion classification circuitry 320 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the motion classification circuitry 320 may be instantiated by any other combination of hardware, software, and/or firmware. For example, the motion classification circuitry 320 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the dynamic pruning circuitry 230 includes means for tagging tokens. For example, the means for tagging tokens may be implemented by the token tagging circuitry 325. In some examples, the token tagging circuitry 325 may be instantiated by programmable circuitry such as the example programmable circuitry 912 of FIG. 9. For instance, the token tagging circuitry 325 may be instantiated by the example microprocessor 1000 of FIG. 10 executing machine executable instructions such as those implemented by at least block 620 of FIG. 6. In some examples, the token tagging circuitry 325 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the token tagging circuitry 325 may be instantiated by any other combination of hardware, software, and/or firmware. For example, the token tagging circuitry 325 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the dynamic pruning circuitry 230 includes means for calculating pruning ratios. For example, the means for calculating pruning ratios may be implemented by the pruning ratio calculation circuitry 330. In some examples, the pruning ratio calculation circuitry 330 may be instantiated by programmable circuitry such as the example programmable circuitry 912 of FIG. 9. For instance, the pruning ratio calculation circuitry 330 may be instantiated by the example microprocessor 1000 of FIG. 10 executing machine executable instructions such as those implemented by at least block 810 of FIG. 8. In some examples, the pruning ratio calculation circuitry 330 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the pruning ratio calculation circuitry 330 may be instantiated by any other combination of hardware, software, and/or firmware. For example, the pruning ratio calculation circuitry 330 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the dynamic pruning circuitry 230 includes means for pruning image tokens. For example, the means for pruning image tokens may be implemented by the token pruning circuitry 335. In some examples, the token pruning circuitry 335 may be instantiated by programmable circuitry such as the example programmable circuitry 912 of FIG. 9. For instance, the token pruning circuitry 335 may be instantiated by the example microprocessor 1000 of FIG. 10 executing machine executable instructions such as those implemented by at least block 625 of FIG. 6 and/or blocks 815-835 of FIG. 8. In some examples, the token pruning circuitry 335 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the token pruning circuitry 335 may be instantiated by any other combination of hardware, software, and/or firmware. For example, the token pruning circuitry 335 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the dynamic pruning circuitry 230 includes means for interfacing with a cache. For example, the means for interfacing with a cache may be implemented by the cache interface circuitry 340. In some examples, the cache interface circuitry 340 may be instantiated by programmable circuitry such as the example programmable circuitry 912 of FIG. 9. For instance, the cache interface circuitry 340 may be instantiated by the example microprocessor 1000 of FIG. 10 executing machine executable instructions such as those implemented by at least block 840 of FIG. 8. In some examples, the cache interface circuitry 340 may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the cache interface circuitry 340 may be instantiated by any other combination of hardware, software, and/or firmware. For example, the cache interface circuitry 340 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the motion-based pruning circuitry 105 of FIG. 1 is illustrated in FIGS. 2-3, one or more of the elements, processes, and/or devices illustrated in FIGS. 2-3 may be combined, divided, re-arranged, omitted, eliminated, and/or implemented in any other way. Further, the example dynamic pruning circuitry 230, the example motion analysis circuitry 235, the example system status circuitry 240, the example learnt attention cache 245, the example segmentation circuitry 305, the example patch tokenizer circuitry 310, the example motion vector evaluation circuitry 315, the example motion classification circuitry 320, the example token tagging circuitry 325, the example pruning ratio calculation circuitry 330, the example token pruning circuitry 335, the example cache interface circuitry 340, the example scene change detection circuitry 345 and/or, more generally, the example motion-based pruning circuitry 105 of FIGS. 2-3, may be implemented by hardware alone or by hardware in combination with software and/or firmware. Thus, for example, any of the example dynamic pruning circuitry 230, the example motion analysis circuitry 235, the example system status circuitry 240, the example learnt attention cache 245, the example segmentation circuitry 305, the example patch tokenizer circuitry 310, the example motion vector evaluation circuitry 315, the example motion classification circuitry 320, the example token tagging circuitry 325, the example pruning ratio calculation circuitry 330, the example token pruning circuitry 335, the example cache interface circuitry 340, the example scene change detection circuitry 345, and/or, more generally, the example motion-based pruning circuitry 105, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example motion-based pruning circuitry 105 of FIGS. 2-3 may include one or more elements, processes, and/or devices in addition to, or instead of, those illustrated in FIGS. 2-3, and/or may include more than one of any or all of the illustrated elements, processes and devices.

Flowchart(s) representative of example machine-readable instructions, which may be executed by programmable circuitry to implement and/or instantiate the motion-based pruning circuitry 105 of FIGS. 2-3 and/or representative of example operations which may be performed by programmable circuitry to implement and/or instantiate the motion-based pruning circuitry 105 of FIGS. 2-3, are shown in FIGS. 6-8. The machine-readable instructions may be one or more executable programs or portion(s) of one or more executable programs for execution by programmable circuitry such as the programmable circuitry 912 shown in the example processor platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 6-8, many other methods of implementing the example motion-based pruning circuitry 105 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above. As used herein, the term “circuitry” refers to at least one “circuit.” Thus, circuitry refers to a circuit or a system of circuits. As used herein, programmable circuitry includes and/or corresponds to at least one programmable circuit.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 6-8 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 6 is a flowchart representative of example machine-readable instructions and/or example operations 600 that may be executed, instantiated, and/or performed by programmable circuitry to implement the example motion-based pruning circuitry 105 of FIGS. 1-3 and, more specifically, the example dynamic pruning circuitry 230 including the motion-based pruning circuitry 105. The example machine-readable instructions and/or the example operations 600 of FIG. 6 begin at block 605, at which the segmentation circuitry 305 of the dynamic pruning circuitry 230 segments a video frame into patches, as described above. At block 610, the patch tokenizer circuitry 310 of the dynamic pruning circuitry 230 determines image tokens corresponding respectively to the patches, as described above. At block 615, the motion classification circuitry 320 of the dynamic pruning circuitry 230 determines respective motion classifications for the patches of the video frame. At block 620, the token tagging circuitry 325 of the dynamic pruning circuitry 230 associates the respective motion classifications with the image tokens corresponding respectively to the patches (e.g., by tagging the image tokens), as described above. At block 625, the token pruning circuitry 335 of the dynamic pruning circuitry 230 causes one or more of the image tokens to be pruned at one or more layers of the multimodal foundation model 205 based on the respective motion classifications, as described above. The example machine-readable instructions and/or the example operations 600 then end.

FIG. 7 is a flowchart representative of example machine-readable instructions and/or example operations 615 that may be executed, instantiated, and/or performed by programmable circuitry to implement the motion classification circuitry 320 of the dynamic pruning circuitry 230 of FIG. 3 and/or perform the processing at block 615 of FIG. 6. The example machine-readable instructions and/or the example operations 615 of FIG. 7 begin at block 705, at which the motion classification circuitry 320 determines whether to perform motion classification on the patches of a current video frame based on available motion data. If motion classification is to be based on available motion data (corresponding to the YES output of block 705), at block 710, the motion classification circuitry 320 selects, based on motion vector quality, whether to use motion vectors or optical flow data to determine the motion data for the patches of the video frame, as described above. For example, the block 710, the motion classification circuitry 320 may obtain the motion vector quality from the motion vector evaluation circuitry 315, as described above. At block 715, the motion classification circuitry 320 determines the motion classifications for the patches of the video frame based on comparisons of the motion data (e.g., the motion vectors and/or the optical flow data depending on the selection) for respective ones of the patches to a threshold, as described above. As also described above, the motion classifications classify ones of the patches as motion patches or no-motion patches.

After block 715, or if motion classification is not to be based on available motion data (corresponding to the NO output of block 705), at block 720, the motion classification circuitry 320 determines whether to perform motion classification on the patches of the current video frame based on patch coding type. If motion classification is to be based on patch coding type (corresponding to the YES output of block 720), at block 725, the motion classification circuitry 320 determines the motion classifications for the patches of the video frame based on whether ones of the patches are associated with inter-frame coding, intra-frame coding or skip coding, as described above.

After block 725, or if motion classification is not to be based on patch coding type (corresponding to the NO output of block 720), at block 730, the motion classification circuitry 320 determines whether to perform motion classification on the patches of the current video frame based on frequency domain coefficients associated with the patches. If motion classification is to be based on frequency domain coefficients (corresponding to the YES output of block 730), at block 735, the motion classification circuitry 320 determines the motion classifications for the patches of the video frame based on respective frequency domain coefficient distributions (e.g., histograms) corresponding to the patches, as described above.

After block 735, or if motion classification is not to be based on frequency domain coefficients (corresponding to the NO output of block 730), at block 730, the motion classification circuitry 320 output the motion classifications for the patches of the video frame, as described above. The example machine-readable instructions and/or the example operations 615 then end.

FIG. 8 is a flowchart representative of example machine-readable instructions and/or example operations 625 that may be executed, instantiated, and/or performed by programmable circuitry to perform the processing at block 625 of FIG. 6. The example machine-readable instructions and/or the example operations 625 of FIG. 8 begin at block 805, at which the token pruning circuitry 335 token tagging circuitry 325 of the dynamic pruning circuitry 230 causes storage of the tagged (e.g., classified) image tokens associated with the current image frame in the learnt attention cache 245, as described above. At block 810, the pruning ratio calculation circuitry 330 of the dynamic pruning circuitry 230 determines a token pruning ratio (e.g., also referred to as a token dropout ratio) based on system status information (e.g., power utilization frequency, operating temperature, etc.), as described above. At block 815, the token pruning circuitry 335 of the dynamic pruning circuitry 230 accesses the tagged (e.g., classified) image tokens for the current image frame and examines the respective motion classifications of the image tokens. At block 820, the token pruning circuitry 335 perform an initial selection of image tokens to prune at the input layer of the multimodal foundation model 205 by prioritizing pruning of motion classified tokens over pruning of no-motion classified tokens to meet the pruning ratio, as described above. In some examples, at block 825, the token pruning circuitry 335 further refine the initial selection of the image tokens to be pruned based on cached data (e.g., such as cached attention scores) obtained from the learnt attention cache 245 and associated with image tokens of a preceding frame, as described above. At block 830, the token pruning circuitry 335 causes the selected image tokens to be pruned at the input layer of the model, as described above. In some examples, at block 835, the token pruning circuitry 335 also causes image tokens to be pruned at other layer(s) of the model based on the motion classifications and/or the cached data associated with the image tokens of the preceding frame, as described above. At block 840, the cache interface circuitry 340 of the dynamic pruning circuitry 230 causes attention information obtained for the image tokens of the current frame from one or more layers of the model to be stored in the learnt attention cache 245, as described above. The example machine-readable instructions and/or the example operations 615 then end.

FIG. 9 is a block diagram of an example programmable circuitry platform 900 structured to execute and/or instantiate the example machine-readable instructions and/or the example operations of FIGS. 6-8 to implement the motion-based pruning circuitry 105 of FIG. 2. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, VPUs, DSPs, and/or microcontrollers from any desired family or manufacturer. The programmable circuitry 912 may be implemented by one or more semiconductor based (e.g., silicon based) devices. In this example, the programmable circuitry 912 implements the example dynamic pruning circuitry 230, the example motion analysis circuitry 235, the example system status circuitry 240, the example segmentation circuitry 305, the example patch tokenizer circuitry 310, the example motion vector evaluation circuitry 315, the example motion classification circuitry 320, the example token tagging circuitry 325, the example pruning ratio calculation circuitry 330, the example token pruning circuitry 335, the example cache interface circuitry 340, the example scene change detection circuitry 345 and/or, more generally, the example motion-based pruning circuitry 105.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916. In the illustrated example, the local memory 913 and/or the main memory 914 implement the example learnt attention cache 245,

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 932, which may be implemented by the machine-readable instructions of FIGS. 6-8, may be stored in the mass storage device 928, in the volatile memory 914, in the non-volatile memory 916, and/or on at least one non-transitory computer-readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 6-8 to effectively instantiate the circuitry of FIG. 2 as logic circuits to perform operations corresponding to those machine-readable instructions. In some such examples, the circuitry of FIG. 2 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine-readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations represented by the flowcharts of FIGS. 6-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine-readable instructions represented by the flowchart(s) of FIGS. 6-8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 6-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6-8. As such, the FPGA circuitry 1100 may be configured and/or structured to effectively instantiate some or all of the operations/functions corresponding to the machine-readable instructions of the flowchart(s) of FIGS. 6-8 as dedicated logic circuits to perform the operations/functions corresponding to those software instructions in a dedicated manner analogous to an ASIC. Therefore, the FPGA circuitry 1100 may perform the operations/functions corresponding to the some or all of the machine-readable instructions of FIGS. 6-8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine-readable instructions of FIGS. 6-8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine-readable instructions represented by the flowchart(s) of FIGS. 6-8 to perform first operation(s)/function(s), the FPGA circuitry 1100 of FIG. 11 may be configured and/or structured to perform second operation(s)/function(s) corresponding to a second portion of the machine-readable instructions represented by the flowcharts of FIG. 6-8, and/or an ASIC may be configured and/or structured to perform third operation(s)/function(s) corresponding to a third portion of the machine-readable instructions represented by the flowcharts of FIGS. 6-8.

It should be understood that some or all of the circuitry of FIG. 2 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 1000 of FIG. 10 may execute machine-readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIG. 2 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

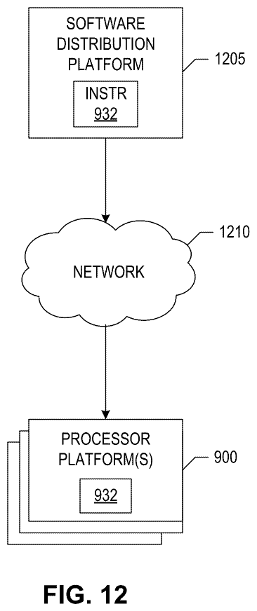

A block diagram illustrating an example software distribution platform 1205 to distribute software such as the example machine-readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine-readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine-readable instructions 932, which may correspond to the example machine-readable instructions of FIGS. 6-8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 932 from the software distribution platform 1205. For example, the software, which may correspond to the example machine-readable instructions of FIG. 6-8, may be downloaded to the example programmable circuitry platform 900, which is to execute the machine-readable instructions 932 to implement the motion-based pruning circuitry 105. In some examples, one or more servers of the software distribution platform 1205 periodically offer, transmit, and/or force updates to the software (e.g., the example machine-readable instructions 932 of FIG. 9) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that perform image token pruning for multimodal foundation models. Disclosed systems, apparatus, articles of manufacture, and methods improve the efficiency of using a computing device by pruning (e.g., dropping, skipping, discarding, etc.) image tokens at one or more layers of the multimodal foundation model based on available motion information to reduce the computation costs and/or other performance degradation(s) caused by the size of the individual tokens. Examples disclosed herein use the available motion information to prune image tokens that are not associated with motion. Such pruned tokens may be redundant relative to other image tokens and/or have little impact on the inference performed by the multimodal foundation model. Because such no-motion image tokens may be redundant and/or have little; inference impact, pruning the no-motion image tokens can achieve improved throughput and/or latency, and/or reduced compute, memory bandwidth and/or power utilization, without sacrificing inference accuracy. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising interface circuitry, machine-readable instructions, and at least one programmable circuit to be programmed based on the machine-readable instructions to determine respective motion classifications for patches of a frame, associate the respective motion classifications with tokens corresponding respectively to the patches, and cause one or more of the tokens to be pruned at a model layer of a multimodal foundation model based on the respective motion classifications.

Example 2 includes the apparatus of example 1, wherein one or more of the at least one programmable circuit is to determine the respective motion classifications based on at least one of motion vectors or optical flow data associated with the patches of the frame.

Example 3 includes the apparatus of example 2, wherein one or more of the at least one programmable circuit is to select whether to use the motion vectors or the optical flow data to determine the respective motion classifications, the selection based on at least one of a bit rate or a compression factor associated with encoded bit stream corresponding to the frame.

Example 4 includes the apparatus of example 2, wherein one or more of the at least one programmable circuit is to determine the respective motion classifications based on a threshold.

Example 5 includes the apparatus of example 1, wherein the frame is decoded from encoded video data, and one or more of the at least one programmable circuit is to determine the respective motion classifications based on respective encoding types associated with corresponding ones of the patches.

Example 6 includes the apparatus of example 5, wherein the respective motion classifications are to classify ones of the patches as motion patches or no-motion patches, and one or more of the at least one programmable circuit is to classify a first one of the patches as a motion patch based on an encoding type of the first one of the patches being inter-frame coding, and classify a second one of the patches as a non-motion patch based on an encoding type of the second one of the patches being intra-frame coding or skip coding.

Example 7 includes the apparatus of example 1, wherein the frame is decoded from encoded video data, and one or more of the at least one programmable circuit is to determine the respective motion classifications based on respective distributions of frequency domain coefficients in the encoded video data, the respective distributions corresponding to ones of the patches of the frame.

Example 8 includes the apparatus of any one of examples 1 to 7, wherein the respective motion classifications are to classify ones of the patches as motion patches or no-motion patches, and one or more of the at least one programmable circuit is to cause ones of the tokens associated with no-motion patches to be prioritized for pruning over ones of the tokens associated with motion patches.

Example 9 includes the apparatus of example 8, wherein one or more of the at least one programmable circuit is to prune ones of the tokens associated with no-motion patches to meet a pruning ratio.

Example 10 includes the apparatus of example 9, wherein one or more of the at least one programmable circuit is to determine the pruning ratio based on system status information.

Example 11 includes the apparatus of example 10, wherein the system status information includes at least one of power utilization or operating temperature.

Example 12 includes the apparatus of any one of examples 1 to 11, wherein the model layer is an input layer of the multimodal foundation model, and one or more of the at least one programmable circuit is to determine the respective motion classifications for the patches of the frame prior to inference being performed by the multimodal foundation model.

Example 13 includes the apparatus of any one of examples 1 to 12, wherein the multimodal foundation model includes a vision language model, and the vision language model is to output video analytics information based on remaining ones of the tokens that are not pruned at the model layer.

Example 14 includes the apparatus of any one of examples 1 to 12, wherein the multimodal foundation model includes a vision language action model, and the vision language action model is to cause a robot to perform an action based on remaining ones of the tokens that are not pruned at the model layer.

Example 15 includes the apparatus of any one of examples 1 to 14, wherein the frame is a first video frame of a video, the tokens are first image tokens, and one or more of the at least one programmable circuit is to cause the first image tokens and the associated motion classifications to be stored in a cache, cause respective attention information corresponding to the first image tokens to be stored in the cache, the respective attention information output from one or more layers of the multimodal foundation model, and cause one or more of second image tokens associated with a subsequent second video frame of the video to be pruned at the model layer of the multimodal foundation model based on data stored in the cache.

Example 16 includes the apparatus of example 15, wherein one or more of the at least one programmable circuit is to cause the cache to be cleared based on detection of a scene change.

Example 17 includes at least one non-transitory computer-readable medium comprising computer-readable instructions to cause at least one programmable circuit to at least determine respective motion classifications for patches of an image, associate the respective motion classifications with tokens corresponding respectively to the patches, and cause one or more of the tokens to be pruned at a model layer of a multimodal foundation model based on the respective motion classifications.

Example 18 includes the at least one non-transitory computer-readable medium of example 17, wherein the computer-readable instructions are to cause one or more of the at least one programmable circuit to determine the respective motion classifications based on at least one of motion vectors or optical flow data associated with the patches.

Example 19 includes the at least one non-transitory computer-readable medium of example 17 or example 18, wherein the respective motion classifications are to classify ones of the patches as motion patches or no-motion patches, and the computer-readable instructions are to cause one or more of the at least one programmable circuit to cause ones of the tokens associated with no-motion patches to be prioritized for pruning over ones of the tokens associated with motion patches.

Example 20 includes the at least one non-transitory computer-readable medium of example 19, wherein the computer-readable instructions are to cause one or more of the at least one programmable circuit to determine a pruning ratio based on system status information, and prune ones of the tokens associated with no-motion patches to meet a pruning ratio.

Example 21 includes a method comprising determining respective motion classifications for patches of a frame, associating the respective motion classifications with tokens corresponding respectively to the patches, and causing one or more of the tokens to be pruned at a model layer of a multimodal foundation model based on the respective motion classifications.

Example 22 includes the method of example 21, including determining the respective motion classifications based on at least one of motion vectors or optical flow data associated with the patches of the frame.

Example 23 includes the method of example 22, including selecting whether to use the motion vectors or the optical flow data to determine the respective motion classifications, the selecting based on at least one of a bit rate or a compression factor associated with encoded bit stream corresponding to the frame.

Example 24 includes the method of example 22, wherein the determining of the respective motion classifications is based on a threshold.

Example 25 includes the method of example 21, wherein the frame is decoded from encoded video data, and including determining the respective motion classifications based on respective encoding types associated with corresponding ones of the patches.

Example 26 includes the method of example 25, wherein the respective motion classifications are to classify ones of the patches as motion patches or no-motion patches, and including classifying a first one of the patches as a motion patch based on an encoding type of the first one of the patches being inter-frame coding, and classifying a second one of the patches as a non-motion patch based on an encoding type of the second one of the patches being intra-frame coding or skip coding.

Example 27 includes the method of example 21, wherein the frame is decoded from encoded video data, and including determining the respective motion classifications based on respective distributions of frequency domain coefficients in the encoded video data, the respective distributions corresponding to ones of the patches of the frame.

Example 28 includes the method of any one of examples 21 to 27, wherein the respective motion classifications are to classify ones of the patches as motion patches or no-motion patches, and the causing of the one or more of the tokens to be pruned includes causing ones of the tokens associated with no-motion patches to be prioritized for pruning over ones of the tokens associated with motion patches.

Example 29 includes the method of example 28, wherein the causing of the one or more of the tokens to be pruned includes pruning ones of the tokens associated with no-motion patches to meet a pruning ratio.

Example 30 includes the method of example 29, wherein the pruning ratio is based on system status information.

Example 31 includes the method of example 30, wherein the system status information includes at least one of power utilization or operating temperature.

Example 32 includes the method of any one of examples 21 to 31, wherein the model layer is an input layer of the multimodal foundation model.

Example 33 includes the method of any one of examples 21 to 32, wherein the multimodal foundation model includes a vision language model, and the vision language model is to output video analytics information based on remaining ones of the tokens that are not pruned at the model layer.

Example 34 includes the method of any one of examples 21 to 32, wherein the multimodal foundation model includes a vision language action model, and the vision language action model is to cause a robot to perform an action based on remaining ones of the tokens that are not pruned at the model layer.

Example 35 includes the method of any one of examples 21 to 34, wherein the frame is a first video frame of a video, the tokens are first image tokens, and including causing the first image tokens and the associated motion classifications to be stored in a cache, causing respective attention information corresponding to the first image tokens to be stored in the cache, the respective attention information output from one or more layers of the multimodal foundation model, and causing one or more of second image tokens associated with a subsequent second video frame of the video to be pruned at the model layer of the multimodal foundation model based on data stored in the cache.

Example 36 includes the method of example 35, including causing the cache to be cleared based on detection of a scene change.

Example 37 includes at least one machine-readable medium comprising machine-readable instructions to cause at least one programmable circuit to perform the method of any one of examples 21 to example 36.

Example 38 includes an apparatus to perform the method of any one of examples 21 to example 36.

Example 39 includes a method performed by any one of the apparatus of examples 1 to example 16.

Example 40 includes at least one machine-readable medium comprising the machine-readable instructions of any one of the apparatus of examples 1 to example 16 includes

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one programmable circuit to be programmed based on the machine-readable instructions to:
determine respective motion classifications for patches of a frame;
associate the respective motion classifications with tokens corresponding respectively to the patches; and
cause one or more of the tokens to be pruned at a model layer of a multimodal foundation model based on the respective motion classifications.

2. The apparatus of claim 1, wherein one or more of the at least one programmable circuit is to determine the respective motion classifications based on at least one of motion vectors or optical flow data associated with the patches of the frame.

3. The apparatus of claim 2, wherein one or more of the at least one programmable circuit is to select whether to use the motion vectors or the optical flow data to determine the respective motion classifications, the selection based on at least one of a bit rate or a compression factor associated with encoded bit stream corresponding to the frame.

4. The apparatus of claim 2, wherein one or more of the at least one programmable circuit is to determine the respective motion classifications based on a threshold.

5. The apparatus of claim 1, wherein the frame is decoded from encoded video data, and one or more of the at least one programmable circuit is to determine the respective motion classifications based on respective encoding types associated with corresponding ones of the patches.

6. The apparatus of claim 5, wherein the respective motion classifications are to classify ones of the patches as motion patches or no-motion patches, and one or more of the at least one programmable circuit is to:
classify a first one of the patches as a motion patch based on an encoding type of the first one of the patches being inter-frame coding; and
classify a second one of the patches as a non-motion patch based on an encoding type of the second one of the patches being intra-frame coding or skip coding.

7. The apparatus of claim 1, wherein the frame is decoded from encoded video data, and one or more of the at least one programmable circuit is to determine the respective motion classifications based on respective distributions of frequency domain coefficients in the encoded video data, the respective distributions corresponding to ones of the patches of the frame.

8. The apparatus of claim 1, wherein the respective motion classifications are to classify ones of the patches as motion patches or no-motion patches, and one or more of the at least one programmable circuit is to cause ones of the tokens associated with no-motion patches to be prioritized for pruning over ones of the tokens associated with motion patches.

9. The apparatus of claim 8, wherein one or more of the at least one programmable circuit is to prune ones of the tokens associated with no-motion patches to meet a pruning ratio.

10. The apparatus of claim 9, wherein one or more of the at least one programmable circuit is to determine the pruning ratio based on system status information.

11. The apparatus of claim 10, wherein the system status information includes at least one of power utilization or operating temperature.

12. The apparatus of claim 1, wherein the model layer is an input layer of the multimodal foundation model, and one or more of the at least one programmable circuit is to determine the respective motion classifications for the patches of the frame prior to inference being performed by the multimodal foundation model.

13. The apparatus of claim 1, wherein the multimodal foundation model includes a vision language model, and the vision language model is to output video analytics information based on remaining ones of the tokens that are not pruned at the model layer.

14. The apparatus of claim 1, wherein the multimodal foundation model includes a vision language action model, and the vision language action model is to cause a robot to perform an action based on remaining ones of the tokens that are not pruned at the model layer.

15. The apparatus of claim 1, wherein the frame is a first video frame of a video, the tokens are first image tokens, and one or more of the at least one programmable circuit is to:
cause the first image tokens and the associated motion classifications to be stored in a cache;
cause respective attention information corresponding to the first image tokens to be stored in the cache, the respective attention information output from one or more layers of the multimodal foundation model; and
cause one or more of second image tokens associated with a subsequent second video frame of the video to be pruned at the model layer of the multimodal foundation model based on data stored in the cache.

16. The apparatus of claim 15, wherein one or more of the at least one programmable circuit is to cause the cache to be cleared based on detection of a scene change.

17. At least one non-transitory computer-readable medium comprising computer-readable instructions to cause at least one programmable circuit to at least:
determine respective motion classifications for patches of an image;
associate the respective motion classifications with tokens corresponding respectively to the patches; and
cause one or more of the tokens to be pruned at a model layer of a multimodal foundation model based on the respective motion classifications.

18. The at least one non-transitory computer-readable medium of claim 17, wherein the computer-readable instructions are to cause one or more of the at least one programmable circuit to determine the respective motion classifications based on at least one of motion vectors or optical flow data associated with the patches.

19. The at least one non-transitory computer-readable medium of claim 17, wherein the respective motion classifications are to classify ones of the patches as motion patches or no-motion patches, and the computer-readable instructions are to cause one or more of the at least one programmable circuit to cause ones of the tokens associated with no-motion patches to be prioritized for pruning over ones of the tokens associated with motion patches.

20. The at least one non-transitory computer-readable medium of claim 19, wherein the computer-readable instructions are to cause one or more of the at least one programmable circuit to:
determine a pruning ratio based on system status information; and
prune ones of the tokens associated with no-motion patches to meet a pruning ratio.
